(19) United States
(12) Patent Application Publication
(10) Pub. No.: US 2002/0076454 A1
(43) Pub. Date: Jun. 20, 2002

(54) Natural insecticide

(76) Inventor: Dennis Bartelmo, San Diego, CA (US)

Correspondence Address: Gary L. Eastman, Esq., EASTMAN & ASSOCIATES, Suite 306, 520 West Ash Street, San Diego, CA, 92101, US

(21) Appl. No.: 09/908,450

(22) Filed: Jul. 17, 2001

Related U.S. Application Data
(60) Provisional application No. 60/218,772, filed on Jul. 17, 2000.

(51) Int. Cl. A01N 65/00

(52) U.S. Cl. 424/751; 424/769; 424/727; 424/747; 424/776

(57) ABSTRACT

The Natural Insecticide includes an aqueous solution of tobacco extracts and a soap mixture which is able to eliminate a wide variety of insects. The Natural Insecticide is completely biodegradable and non-toxic to invertebrates at the usage concentration required. Natural Insecticide is able to prevent the introduction of high levels of insecticide into the environment by remaining effective over a period of time, thereby avoiding the need for numerous applications.

### RELATED APPLICATIONS

This Application is a Continuation-in-Part of U.S. Provisional Patent application of the same title, Serial No. 60/218,772, filed Jul. 17, 2000, and currently co-pending.

### FIELD OF THE INVENTION

The present invention relates generally to insecticidal compounds. More specifically, the present invention pertains to an environmentally safe natural insecticidal solution, which includes an aqueous solution of tobacco extracts and a soap mixture. The present invention is particularly, though not exclusively, useful for eliminating a broad range of insects using a natural, biodegradable, solution.

### BACKGROUND OF THE INVENTION

Insecticides are an important part of modern agricultural and horticultural productivity. Unfortunately, a number of highly effective insecticides are extremely harmful to both the environment and humans. Some of the most effective insecticides are synthetic. One significant problem with synthetic insecticides is their longevity. This longevity is mostly due to the fact that many synthetic insecticides are not biodegradable. Consequently, these insecticides remain in the ecosystem for long periods of time, and can have disastrous consequences on organisms who subsequently absorb the insecticide. DDT is a good example of a synthetic insecticide that remained in the ecosystem for a long period of time, and has had considerable negative consequences.

Over the years, efforts have been made to develop insecticides that are as effective as synthetic insecticides, and yet are able to be quickly absorbed into the ecosystem. One possible solution that has been explored is the development of insecticides from naturally occurring compounds. The premise of this development was that since the compounds are naturally occurring, they would be easily absorbed into the ecosystem without lasting ill effects. Unfortunately, currently available naturally occurring insecticides are either less effective than synthetic insecticides, or are themselves toxic.

In addition to the ability to be absorbed and broken down in the ecosystem, it is also important that an insecticide is able to remain effective over time. This eliminates the need for repeated applications, a situation which leads to a build up of the insecticide in the surrounding soil. The insecticide is then spread by subsequent rains, which results in the insecticide having ecological effects far removed from the spraying sight. In this situation, an insecticide which is benign at low levels, can become an environmental toxin due to its presence in the ecosystem at high levels. An insecticide which is able to remain effective for a long period of time subsequent to the application removes this need for repeated applications, thereby reducing the overall presence of the insecticide in the environment. Therefore, currently a choice must be made between an insecticide which is highly effective but damaging to the ecosystem, or an insecticide which is environmentally friendly but has a low level of effectiveness.

Consequently, there is a need for a naturally occurring insecticide which is effective, able to remain active for more then a sort period of time, and is able to be easily absorbed into the ecosystem in order to avoid lasting ecological harm.

Accordingly, it is an object of the present invention to provide a new and useful Natural Insecticide that may control a broad variety of insects, while being environmentally safe. It is also an object of the present invention to provide a Natural Insecticide that is entirely biodegradable. It is still another object of the present invention to provide a Natural Insecticide which minimizes the need for repeat application by maintaining its effectiveness over a period of time beyond the initial application. It is another object of this invention to provide a Natural Insecticide that is capable of eliminating Whiteflies, both Domestic and Silverwing, Aphids, both Black and White, Spider Mites, and a variety of other insects. It a further object to provide a Natural Insecticide in an aqueous form so that it may be applied by spraying or misting the Natural Insecticide directly on plants or insects.

### SUMMARY OF THE INVENTION

In accordance with the present invention, a Natural Insecticide is provided and includes an aqueous solution of tobacco extracts and a soap mixture. The Natural Insecticide may be applied to an insect infested area by spraying or other method well known in the art. The Natural Insecticide may be used to control a wide variety of common garden pests, including, but not limited to, Whiteflies, Aphids, and Spider Mites, while remaining completely biodegradable.

The Natural Insecticide as described above will overcome the disadvantages of currently available insecticides. For example, the Natural Insecticide of the present invention will effectively eliminate a wide variety of insects while being both completely biodegradable and non-toxic to vertebrates at the usage concentration.

### DESCRIPTION OF THE DRAWING

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a flow chart showing the manufacturing process of the Natural Insecticide of the present invention.

### DETAILED DESCRIPTION

The Natural Insecticide of the present invention may include an aqueous solution of tobacco extracts and a soap mixture. The Natural Insecticide is able to effectively eliminate insects through the combined effects of the tobacco extracts and the soap mixture. The tobacco extracts are an important insecticidal agent in the Natural Insecticide of the present invention. The tobacco extracts are those chemicals naturally present in tobacco which may be removed by steeping tobacco leaves in water. This process removes a variety of chemicals from the tobacco, including nicotine, which is an effective insecticide itself. Nicotine primarily effects piercing and sucking insects, such as Aphids, Whiteflies, Leaf Hoppers, and Thrips. The tobacco extracts, including the nicotine, are able to penetrate the insect's body both dermaly and through ingestion. Either method is effective in eliminating insects. In the present invention, the tobacco extracts, including the nicotine, are present in a sufficiently diluted form so as to be non-toxic to humans and other warm blooded animals. This ability to use a diluted form of the tobacco extracts is due to the presence of the soap mixture in the Natural Insecticide of the present invention.

The soap mixture contributes to the elimination of insects in several way. First, the soap mixture acts as a surfactant which lowers the surface tension of the Natural Insecticide. This allows the tobacco extracts to more easily penetrate the insect's system and cause the insects death. Consequently the tobacco extracts may be sufficiently dilute to effectively eliminate insects while remaining non-toxic to warm blooded animals. Second, the inclusion of the soap mixture causes the Natural Insecticide to adhere to the plant leaves, and other plant structures, thereby increasing the effective life of the Natural Insecticide. By adhering to plants subsequent to application, the Natural Insecticide is able to continue its effective life by eliminating insects that subsequently contact or ingest the coated plant matter. As a result, the Natural Insecticide only has to be applied once every two (2) or three (3) weeks, thereby minimizing the build up of the Natural Insecticide in the surrounding soil.

The soap mixture functions, independent of the tobacco extracts, as an insecticide. More specifically, the soap mixture acts as an effective insecticide against soft bodied insects such as aphids and whiteflies. By combining the soap mixture of the present invention with the tobacco extracts, the insecticidal efficacy of the Natural Insecticide is much greater then that found by using either the soap mixture or the tobacco extracts alone.

The Natural Insecticide of the present invention is entirely biodegradable. The Natural Insecticide is a combination of natural compounds which, because of its effectiveness at diluted levels, does not have to be applied excessively or repeatedly. Both the tobacco extracts and the soap mixture, are composed entirely of compounds that occur naturally. They are entirely biodegradable, and at the dosage levels required, are toxic to insects yet are environmentally benign.

Method of Manufacturing

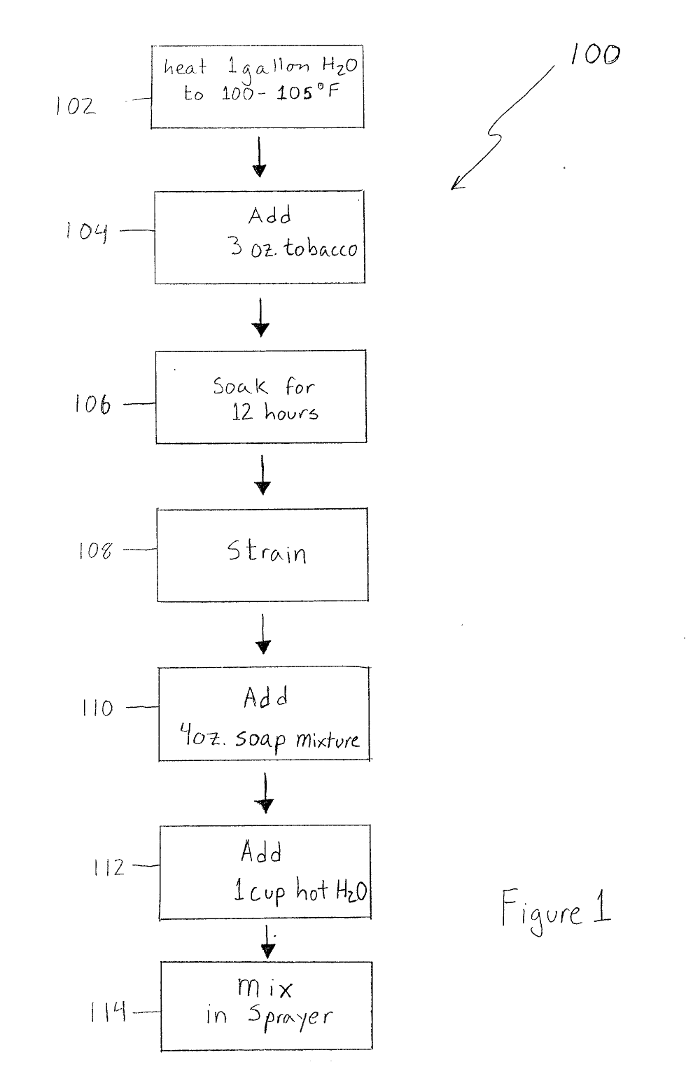

Referring now to FIG. 1, manufacturing process 100 of the Natural Insecticide of the present invention is shown and includes steps 102 through 112. In a preferred embodiment, manufacturing process 100 is completed by performing steps 102 through 112 in order, starting with step 102 and proceeding sequentially through step 112.

Step 102: Heat one (1) gallon of water to approximately 100-105 degrees Fahrenheit. In a preferred embodiment, the water is simply hot tap water, although any method of heating may be used, so long as the water is at a temperature which will leach the tobacco extracts from the tobacco.

Step 104: Add three (3) ounces of tobacco to the hot water. In a preferred embodiment, the tobacco may three may be (3) ounces of chewing tobacco.

Step 106: Soak the tobacco in the water for at least 12 hours. Although, soaking times shorter or longer may be used so long as the resulting solution includes the necessary tobacco extracts.

Step 108: Remove the tobacco by straining the solution using a cheese cloth and strainer. However, it should be noted, that any other means well known in the art may be used to remove the tobacco leaves from the solution.

Step 110: Add four (4) ounces of the soap mixture to the strained solution. The soap mixture of the present invention is a pure castile soap which may include a combination of natural oils. In a preferred embodiment the soap mixture is Dr. Bronner's PEPPERMINT Pure-Castile Soap. However, any combination of natural oils, including coconut oil, hemp oil, jojoba oil, olive oil, and peppermint oil, or other commercially available pure castile soaps may be used, so long as they have similar insecticidal and adhesive qualities.

Step 112: Heat one (1) cup of water to 100 degrees centigrade, and then add the heated water to the solution in order to rinse the soap mixture and activate the solution.

Step 114: Add the solution to sprayer and mix to homogenize the completed Natural Insecticide.

It should be noted, however, that the above listed steps are a preferred embodiment, and that the Natural Insecticide of the present invention may be formed by any means well known in the art so that the active ingredients of the tobacco extracts are combined with the soap mixture in an aqueous solution.

Method of Use

In a preferred embodiment, the aqueous solution of the Natural Insecticide may be applied to an insect infested area by means of spraying or misting. For example, the Natural Insecticide could be used to fill a pressurized canister, such as a “Hudson” sprayer, so that the Natural Insecticide may be sprayed onto the insect infested area. For example, the Natural Insecticide may be sprayed directly on aphids on the top of leaves, or on whiteflies on the underside of leaves. It is important to note, however, that the Natural Insecticide may be applied by using any type of spray system, aerosol, misting system, or any other application method for the application of liquid insecticides that is well known in the art.

While the Natural Insecticide of the present invention as herein shown and disclosed in detail is fully capable of obtaining and providing the advantages herein before stated, it is to be understood that it is merely illustrative of a preferred embodiment of the invention and that no limitations are intended to the details of construction or design herein shown other than as described in the appended claims.

I claim:

1. A natural insecticidal compound comprising:
an aqueous solution of tobacco extracts; and
a soap mixture.

2. The natural insecticidal compound of claim 1 wherein said tobacco extracts comprise the chemicals naturally present in tobacco.

3. The natural insecticidal compound of claim 2 wherein said soap mixture comprises a pure castile soap.

4. The natural insecticidal compound of claim 3 wherein said pure castile soap comprises any one or combination of coconut oil, hemp oil, jojoba oil, olive oil, or peppermint oil.

5. The natural insecticidal compound of claim 1 wherein said soap mixture comprises a pure castile soap.

6. The natural insecticidal compound of claim 5 wherein said pure castile soap comprises any one or combination of coconut oil, hemp oil, jojoba oil, olive oil, or peppermint oil.

7. A method of manufacturing a natural insecticide comprising the steps of:
heating a first quantity of water;
adding a quantity of tobacco to said first quantity of water to form a solution;
soaking said tobacco in said solution;
straining said quantity of tobacco from said solution to form a strained solution; and
adding a quantity of a soap mixture to said strained solution to form a strained soap solution.

8. The method of claim 7, further comprising:
adding a second quantity of hot water to said strained soap solution; and
mixing said second quantity of hot water and said strained soap solution to create a natural insecticide.

9. The method of claim 8 wherein a ratio of said strained soap solution to second quantity of water is 1 gallon to 1 cup.

10. The method of claim 7 wherein first quantity of water is one (1) gallon.

11. The method of claim 7 wherein said first quantity of water is heated to a temperature suitable for leaching tobacco extracts from said quantity of tobacco.

12. The method of claim 7 wherein a ratio of said first quantity of water to said quantity of tobacco is 1 gallon to 3 ounces.

13. The method of claim 7 wherein said quantity of tobacco comprises chewing tobacco.

14. The method of claim 7 wherein said soaking period is for a period of time suitable for leaching tobacco extracts from said quantity of tobacco.

15. The method of claim 14 wherein said soaking period is 12 hours.

16. The method of claim 7 wherein said straining comprises passing said solution through a porous membrane.

17. The method of claim 14, wherein said porous membrane further comprises cheese cloth.

18. The method of claim 7 wherein the ratio of said solution to said soap mixture is 1 gallon to 4 ounces.

19. The method of claim 7 wherein said soap mixture comprises a pure castile soap.

20. The method of claim 19 wherein said castile soap comprises any one or combination coconut oil, hemp oil, jojoba oil, olive oil, and peppermint oil.

21. A method of minimizing insect infestation on a surface comprising the steps of:
creating a natural insecticidal compound by mixing an aqueous solution of tobacco extracts with a soap mixture; and
applying said natural insecticidal compound to said surface.

22. The method of claim #, wherein said natural insecticidal compound further comprises an aqueous solution of tobacco extracts and a soap mixture.
